(19) United States
(12) Patent Application Publication
(10) Pub. No.: US 2006/0285161 A1
(43) Pub. Date: Dec. 21, 2006

(54) Overlay printing device

(75) Inventor: Junichi Otsuka, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/330,886

(22) Filed: Jan. 11, 2006

(30) Foreign Application Priority Data
Jan. 11, 2005 (JP) 2005-003642

(51) Int. Cl. G06T 11/60

(52) U.S. Cl. 358/1.18

(57) ABSTRACT

An overlay data processing method of the invention controls a printer to print a calibration pattern at a predetermined printing position on preset printing paper set in the printer, and controls a scanner to scan the printing paper with the printed calibration pattern. The overlay data processing method then computes a deviation between a printable area of the printer and a scannable area of the scanner, based on the printing position of the calibration pattern and a scanned position of the calibration pattern by the scanner. The overlay data processing method displays an image of a selected form scanned by the scanner on a monitor screen and lays out entered overlay data, for example, an entered character string, on the displayed form image. The overlay data processing method controls the printer to print the laid-out overlay data at a corrected printing position, which has an offset corresponding to the computed deviation, on the selected form. This technique of the invention enables desired overlay data to be printed on a selected form, for example, printing paper with a printed layout frame, with high accuracy.

### CLAIM Of PRIORITY

The present application claims the priority from Japanese application P2005-3642A filed on Jan. 11, 2004, the contents of which are hereby incorporated by reference into this application.

### BACKGROUND OF THE INVENTION

1. Field of the Invention

The present invention relates to an overlay data processing method that prints overlay data on a predetermined form with a scanner or a printer, as well as to a corresponding overlay data processing device.

2. Description of the Related Art

There is a difficulty in adjustment of the printing position of an entered character string on a postcard, a label, a slip, or any other form with a layout frame printed in advance. Part of the character string may thus be printed outside the layout frame. There are similar difficulties in adjustment of the printing position of an additional character string in a vacant space on printing paper with some picture printed in advance and in adjustment of the printing positions of strikethroughs over a printed form. Another difficulty is adjustment of the size balance and the color balance between characters printed in advance and additional characters printed afterwards.

One proposed technique disclosed in Japanese Patent Laid-Open Gazette No. 9-6863 controls a scanner to read a layout structure of a desired form and generate electronic data of the layout structure and subsequently controls a printer to simultaneously print the layout frame and an entered character string on printing paper.

This prior art technique simultaneously prints the layout frame and the character string and thus ensures printing of the character string within the layout frame. This technique, however, does not take into account the case of printing a character string on printing paper with a layout frame, some characters, or some picture printed in advance.

### SUMMARY

The object of the invention is thus to eliminate the drawbacks of the prior art techniques and to enable layout of desired overlay data as an object of printing on a selected form with high accuracy.

In order to attain at least part of the above and the other related objects, one aspect of the present invention is directed to an overlay data processing method that is executed by a computer connected with at least a scanner to process overlay data. The overlay data processing method includes the steps of: controlling the scanner to scan a selected form and generate a scanned form image; displaying the scanned form image on a display screen; receiving entry of overlay data, which is to be printed on the selected form; laying out the entered overlay data on the displayed form image; and determining a relative printing position of the laid-out overlay data on the selected form by taking into account a deviation of a scanning position by the scanner.

There is an overlay data processing device corresponding to the overlay data processing method. The aspect of the invention is thus directed to an overlay data processing device that prints overlay data on a selected form. The overlay data processing device includes: a scanner that scans an image; a form image generation unit that controls the scanner to scan the selected form and generate a scanned form image; a display unit that displays the scanned form image on a display screen; an overlay data entry unit that receives entry of overlay data, which is to be printed on the selected form; a layout unit that lays out the overlay data entered by the overlay data entry unit on the displayed form image; and a printing position determination unit that determines a relative printing position of the laid-out overlay data on the selected form by taking into account a deviation of a scanning position by the scanner.

The overlay data processing method or the corresponding overlay data processing device enables the user to lay out desired overlay data, for example, a character string, while visually checking an image of a selected form scanned by the scanner and displayed on the display screen. The technique of the device and the method facilitates adjustment of the printing position, the size, and the color of the overlay data and enables the adjusted overlay data to be printed on the selected form with high accuracy. In the printing process, the overlay data processing method or the corresponding overlay data processing device does not output the scanned form image or an image representing a preset layout frame but outputs only the adjusted overlay data, for example, the adjusted character string, as print data to the printer. This arrangement desirably enhances the printing speed. The computer is connected with at least the scanner and may further be connected with a printer. The scanner and the printer may be connected as individual, separate devices to the overlay data processing device or may be incorporated in an identical casing. One typical example of the latter structure is a complex machine having both the functions of the scanner and the printer.

In the overlay data processing method and the corresponding overlay data processing device, the terminology ‘form’ is not restricted to printing papers with layout frames printed in advance, such as slips, but includes printing papers with some characters, pictures, or figures printed in advance. The ‘form’ of the invention includes, for example, postcards and envelopes with printed frames for zip codes or postcodes, writing papers and labels with ruled lines, name cards with some printed information like the company name and the personal name, postcards and new year cards with printed pictures and characters. The ‘overlay data to be printed on the selected form’ includes, for example, letters, characters, bitmap data, barcodes, 2D codes, and figures.

In one preferable embodiment of the invention, the overlay data processing method further includes the steps of controlling a printer connected to the computer to print a calibration pattern at a predetermined printing position on preset printing paper set in the printer; controlling the scanner to scan the printing paper with the printed calibration pattern; computing a deviation between a printable area of the printer and a scannable area of the scanner, based on the printing position of the calibration pattern and a scanned position of the calibration pattern by the scanner; calculating a correction amount of the relative printing position of the overlay data from the computed deviation to determine a corrected printing position of the overlay data on the selected form; and controlling the printer to print the overlay data at the corrected printing position on the selected form set in the printer.

The arrangement of this embodiment is also applicable to the overlay data processing device.

The arrangement of the embodiment enables compensation for the deviation between the printable area of the printer and the scannable area of the scanner, thus further enhancing the accuracy of printing on the selected form.

In the overlay data processing method of this embodiment, it is preferable that the calibration pattern printing step prints a predetermined index for clearly indicating a top and a bottom of the printing paper, simultaneously with printing the calibration pattern.

This arrangement effectively prevents the user from setting the printing paper with the printed calibration pattern in a wrong orientation in the scanner.

The calibration pattern may include multiple marks of a predetermined shape.

The overlay data processing method in this application specifies a deviation of each mark and computes the average of the specified deviations of the multiple marks. This enables determination of the deviation with higher accuracy. A rotational deviation may additionally be detected by specifying the slope of a straight line interconnecting two of the multiple marks.

In one preferable example, the multiple marks have a circular shape. The circular shape enables easy determination of the center point of each mark, even when there is a rotational deviation between the printable area and the scannable area.

In the overlay data processing method of this embodiment, it is preferable that the overlay data printing step controls the printer to print the overlay data at the corrected printing position in a maximum printable paper size, regardless of a size of the selected form actually set in the printer. This application ensures printing of the overlay data to the respective edges (especially to the lower edge and the right edge) of the selected form. Such fixation of the printing size to the maximum printable paper size does not require the user to individually set the size of each form in the printer driver and thus enhances the user's convenience in printing of overlay data on the selected form.

The technique of the invention is not restricted to the overlay data processing method or the corresponding overlay data processing device, but may be actualized by a computer program that causes a computer to print overlay data. The computer program may be recorded in a computer readable recording medium. Typical examples of the recording medium include flexible disks, CD-ROMs, magneto-optical disks, and memory cards.

### BRIEF DESCRIPTION OF THE DRAWINGS

FIG. 1 schematically illustrates the configuration of an overlay data processing device in one embodiment of the invention;

FIG. 2 shows one example of an application window;

FIG. 3 is a flowchart showing a calibration process;

FIG. 4 shows one example of a calibration pattern;

FIG. 5 shows a scannable area SA relative to a scan plane by a scanner;

FIGS. 6A and 6B conceptually show a process of determining a center point of each mark; and

FIG. 7 is a flowchart showing overlay data printing process.

### DESCRIPTION OF THE PREFERRED EMBODIMENTS

In order to clarify the functions and the effects of the invention, one mode of carrying out the invention is described below as a preferred embodiment in the following sequence with reference to the accompanied drawings:

A. General Configuration of Overlay Data Processing Device

B. Calibration Process

C. Overlay Data Printing Process

A. General Configuration of Overlay Data Processing Device

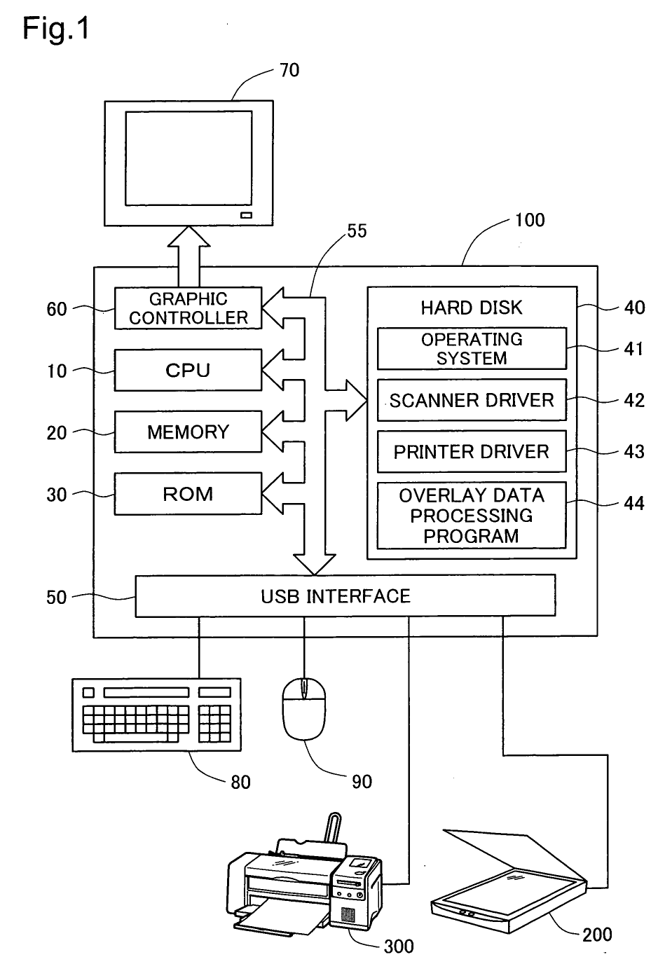

FIG. 1 schematically illustrates the general configuration of an overlay data processing device 100 in one embodiment of the invention. As illustrated, the overlay data processing device 100 of the embodiment is constructed as a computer system including a central processing unit or CPU 10, a main storage device or memory 20, a ROM 30 with a BIOS (Basic Input-Output System) stored therein, a hard disk 40 with various software programs installed therein, an USB interface 50 for connection with peripheral equipment, and a graphic controller 60 for display control on a monitor 70. These hardware constituents are mutually connected via a preset bus 55.

The USB interface 50 is connected with a keyboard 80, a mouse 90, a scanner 200 that optically scans a predetermined form to obtain a form image, and a printer 300 that prints overlay data on the predetermined form. The scanner 200 may be any of various scanners, for example, a flathead scanner or a sheet feeder scanner. The printer 300 may be any of various printers, for example, an inkjet printer, a laser printer, a thermal transfer printer, or a dot impact printer. In the structure of this embodiment, the scanner 200 and the printer 300 are individually connected to the overlay data processing device 100. A complex machine having both the functions of a scanner and the functions of a printer may alternatively be connected to the overlay data processing device 100. The scanner 200 and the printer 300 are linked to the overlay data processing device 100 by USB connection. The USB connection may be replaced by any of RS-232C connection, parallel port connection, IEEE1394 connection, and network connection. The keyboard 80 and the mouse 90 are also linked to the overlay data processing device 100 by USB connection. The keyboard 80 and the mouse 90 may be connected to the overlay data processing device 100 via a keyboard interface and a PS/2 interface.

The hard disk 40 stores various software programs, that is, an operating system 41 as a basic software program for general control of the overlay data processing device 100, a scanner driver 42 for control of the scanner 200, and a printer driver 43 for control of the printer 300. An overlay data processing program 44 is also installed in the hard disk 40 and is executed to edit overlay data to be printed and print the edited overlay data on a predetermined form with the scanner 200 or the printer 300. The CPU 10 executes these software programs with the memory 20 used as a work area. The overlay data processing program 44 may be stored in a computer readable recording medium, such as a flexible disk or a CD-ROM and may be installed from the recording medium into the hard disk 40 by a specific installer. The overlay data processing program 44 may otherwise be read directly from the recording medium to be executed.

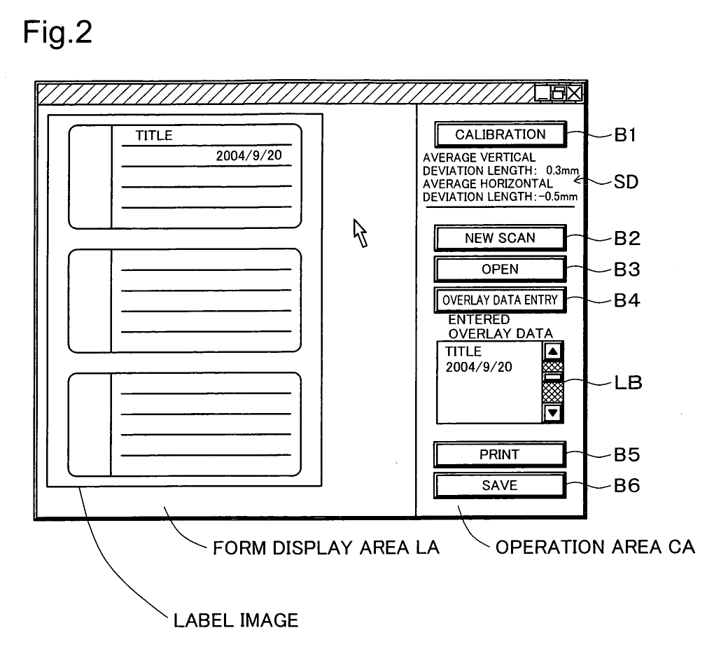

FIG. 2 shows one example of an application window open on the monitor 70 by execution of the overlay data processing program 44 by the CPU 10. In the illustrated example, the application window has two panes, a form display area LA and an operation area CA. The form display area LA displays a form image obtained by scanning a predetermined form by the scanner 200, a label image in the illustrated example. The operation area CA has various operation buttons, for example, a Calibration button B1, a New Scan button B2, an Open button B3, an Overlay Data Entry button B4, a Print button B5, and a Save button B6. The operation area CA also has a deviation display field SD for displaying deviation lengths computed by a calibration process (described later) and a list box LB for displaying a list of entered overlay data.

In response to the user's click of the Overlay Data Entry button B4 on the application window with a pointing device, for example, the mouse 90, the operation window is set in an overlay data entry mode. The user operates the mouse 90 to shift the cursor over the form display area LA and manipulates the keyboard 80 to enter desired overlay data at any arbitrary position in the form display area LA. In the illustrated example, character strings ‘TITLE’ and ‘2004/9/20’ are laid out as overlay data on a label image with ruled lines as the predetermined form. The overlay data processing program 44 outputs the laid-out overlay data to the printer 300 to print the overlay data on the predetermined form, that is, an actual label. The overlay data processing program 44 enables the user to lay out desired overlay data on an image of the predetermined form displayed on the monitor 70. This arrangement ensures printing of desired overlay data on the predetermined form with high accuracy.

B. Calibration Process

The scanners generally have unscannable ranges of several millimeters from the circumferential edges of each scan plane, because of the structural limitation of the optical scanning mechanism. The printers, except some inkjet printers, generally have unprintable ranges of several millimeters or a few centimeters from the circumferential edges of each printing paper, because of the structural limitation of the printing mechanism. Namely each model or each individual unit of the scanner or the printer has a fixed scannable area or fixed printable area. The overlay data processing device 100 of this embodiment executes the calibration process described below to adjust a variation of the scannable area or the printable area and print the overlay data on a predetermined form with high accuracy.

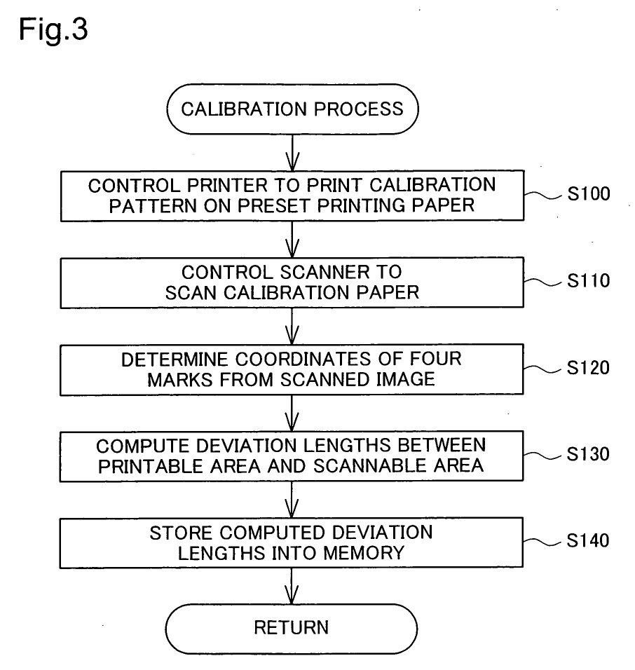

FIG. 3 is a flowchart showing a flow of the calibration process. The calibration process is called by the user's click of the Calibration button B1 (see FIG. 2) with the mouse 90 during execution of the overlay data processing program 44. The calibration process may automatically be executed on the occasion of first execution of the overlay data processing program 44 or in response to detection of replacement of the connected scanner 200 or the connected printer 300 to another model.

In the call of the calibration process, the CPU 10 of the overlay data processing device 100 first controls the printer 300 to print a calibration pattern on preset printing paper set in the printer 300 (step S100).

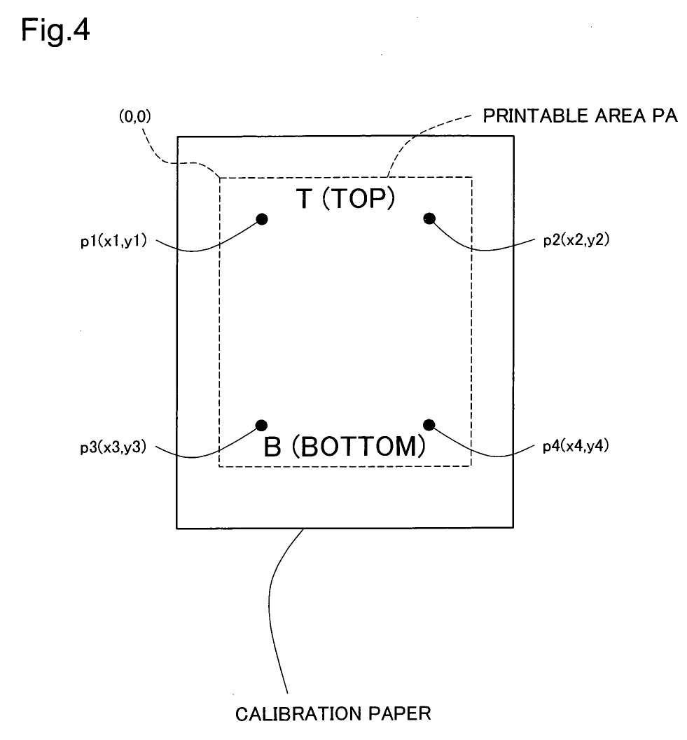

FIG. 4 shows one example of the printed calibration pattern. The printer 300 of the embodiment is capable of printing in a printable area PA defined by the broken line. The CPU 10 prints four marks p1 to p4 at preset positions having specific margins from the four corners of the printable area PA. The position of the printable area PA is specified by an inquiry to the printer driver 43. The four marks p1 to p4 are closed black circles of approximately 5 mm in diameter. In this embodiment, these four marks p1 to p4 form the calibration pattern. The coordinates (center points) of these four marks are determined relative to the coordinates at the upper left corner of the printable area

PA as the origin:

p1=(x1,y1)

p2=(x2,y2)

p3=(x3,y3),

p4=(x4,y4)

The CPU 10 prints characters T (top) and B (bottom) on the top and the bottom of the preset printing paper, simultaneously with printing the calibration pattern. These printed characters T and B are used as indexes to indicate the user the orientation of the printing paper with the calibration pattern printed thereon (hereafter referred to as the calibration paper) to be set in the scanner 200 (at step S120 as described later). Although both the characters T and B are printed on the printing paper in this embodiment, only one of these characters T and B may be printed. These characters may be replaced by any suitable symbols, such as direction-pointing arrows.

One preferable procedure of step S100 opens a dialog box giving a message like ‘Set A4 paper in the printer. A calibration pattern will be printed’, prior to the actual printing of the calibration pattern. In response to the user's click of an OK button in the dialog box, the CPU 10 controls the printer 300 to start printing the calibration pattern on the preset printing paper. This application enables the user to set the printing paper of a right size in the printer 300 for adequate printing.

On completion of printing the calibration pattern, the CPU 10 controls the scanner 200 to scan the calibration paper (step S110). One preferable procedure of step S110 opens a dialog box giving a message like ‘Set the paper with the print of the calibration pattern in a correct orientation in the scanner’, prior to the actual scanning of the calibration paper. In response to the user's click of an OK button in the dialog box, the CPU 10 controls the scanner 200 to start scanning the calibration paper. This application prevents the scanner 200 from starting scanning without the calibration paper set in the scanner 200 or from scanning the calibration paper set in a wrong orientation.

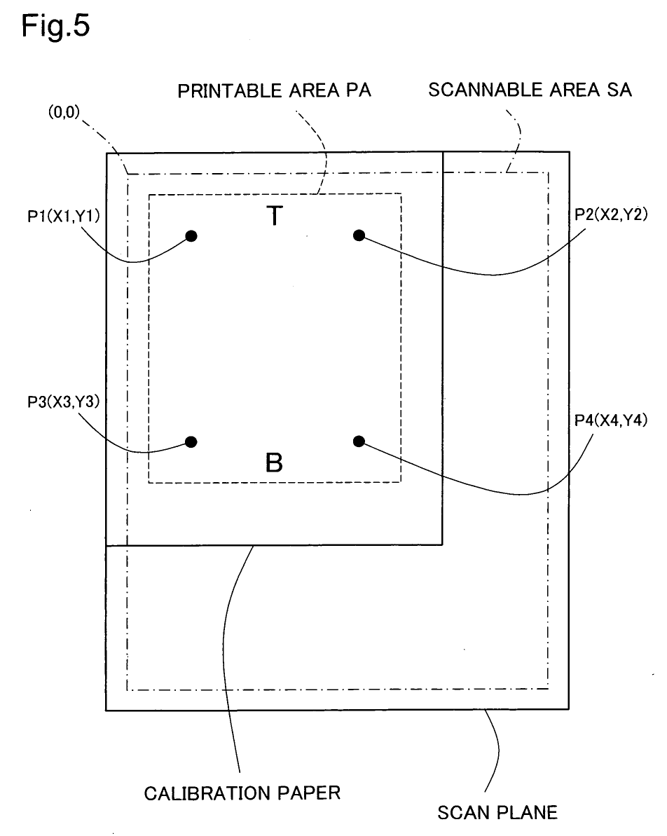

FIG. 5 shows a scannable area SA relative to a scan plane by the scanner 200. In this embodiment, the scanner 200 is capable of scanning an image within the scannable area SA defined by the one-dot chain line. The scannable area SA is slightly narrower than the scan plane as clearly shown in FIG. 5. There are accordingly unscannable ranges along an upper edge and a left edge of the calibration paper. For the purpose of reference, the printable area PA of the printer 300 is also shown by the broken line in FIG. 5.

The CPU 10 then determines the coordinates (center points) of the four marks constituting the calibration pattern on an image of the calibration paper scanned by the scanner 200 (step S120).

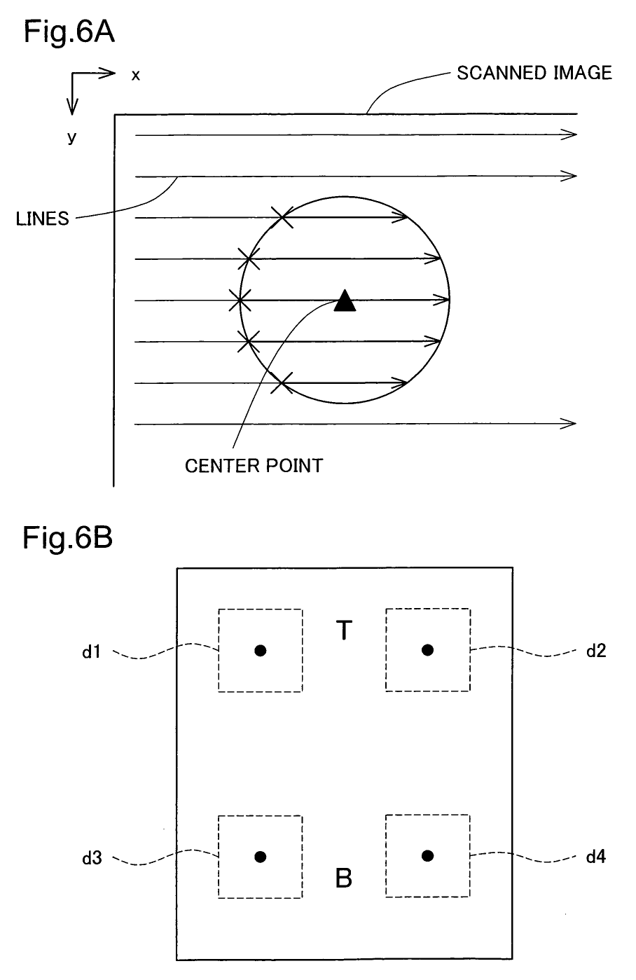

FIGS. 6A and 6B conceptually show a process of determining a center point of each mark. For the clarity of illustration, the mark printed as a closed black circle is expressed as an open circle in FIG. 6A. The CPU 10 sequentially scans individual pixels on respective lines in an illustrated direction ‘x’ from the coordinates of an upper left corner to the coordinates of a lower right corner on the scanned image. When the scan finds a first black pixel (shown by a symbol ‘x’), the CPU 10 specifies the width of a continuous black area from the first black pixel in the direction ‘x’. For the avoidance of possible effects of dust and noise, the first black pixel may be neglected when the specified width of the continuous black area is less than a predetermined width, for example, a width of 3 pixels. This scan is continued for a preset number of lines exceeding the diameter of the mark. The coordinate of a specific line having the maximum width of the continuous black area among the preset number of lines is determined as a ‘y’ coordinate of the mark. The middle point of the continuous black area on the specific line at the ‘y’ coordinate is then determined as an ‘x’ coordinate of the mark. This scanning process accordingly determines the center point of the mark.

The procedure of this embodiment sets detection areas d1 to d4 as target areas for detection of the marks as shown in FIG. 6B and determines the center points of the respective marks in these detection areas d1 to d4. This desirably relieves the total processing load and effectively prevents detection of the marks from being affected by the presence of the printed characters T (top) and B (bottom) on the calibration paper.

The coordinates (center points) of the four scanned marks are determined relative to the coordinates at the upper left corner of the scannable area

SA as the origin:

P1=(X1, Y1)

P2=(X2, Y2)

P3=(X3, Y3),

P4=(X4, Y4)

Referring back to the flowchart of FIG. 3, the CPU 10 computes deviation lengths between the origin of the printable area PA and the origin of the scannable area SA (see FIG. 5) (step S130). A concrete procedure of step S130 calculates the differences between the scanned positions (coordinates) of the four scanned marks at step S120 and the printing positions (coordinates) of the four printed marks at step S100 and computes the averages of these calculated differences as the deviation lengths.

The differences between the scanned positions and the printing positions of the respective marks are given as:

Δp1=(X1−x1, Y1−y1)

Δp2=(X2−x2, Y2−y2)

Δp3=(X3−x3, Y3−y3)

Δp4=(X4−x4, Y4−y4)

The computed averages of these differences are:

Δx (deviation length in ‘x’ direction)=((X1−x1)+(X2−x2)+(X3−x3)+(X4−x4))/4

Δy (deviation length in ‘y’ direction)=((Y1−y1)+(Y2−y2)+(Y3−y3)+(Y4−y4))/4

In the case where the printing resolution of the four marks is different from the scanning resolution of the four marks, the coordinates determined at step S120 are converted corresponding to the printing resolution. For example, when the printing resolution is 1200 dpi and the scanning resolution is 300 dpi, the coordinates determined at step S120 are quadrupled. Such conversion specifies the deviation lengths in the printing resolution.

The CPU 10 stores the computed deviation lengths into the memory 20 or the hard disk 40 (step S140). The stored deviation lengths are read out and used for correction of the printing position in a subsequent overlay data printing process as described below.

The procedure of this embodiment computes the averages of the differences between the printing positions and the scanned positions of the four marks. One possible modification may additionally compute a rotational deviation between the printable area PA and the scannable area SA from the coordinates of the four printed marks and the coordinates of the four scanned marks. This further enhances the accuracy for printing on the predetermined form. One concrete procedure of such modification calculates the slope of a straight line connecting the coordinates of the mark P2 with the coordinates of the mark P1 and the slope of a straight line connecting the coordinates of the mark P4 with the coordinates of the mark P3. The modified procedure then computes the average of these two calculated slopes as a rotational deviation and stores the computed rotational deviation into the memory 20 or the hard disk 40.

C. Overlay Data Printing Process

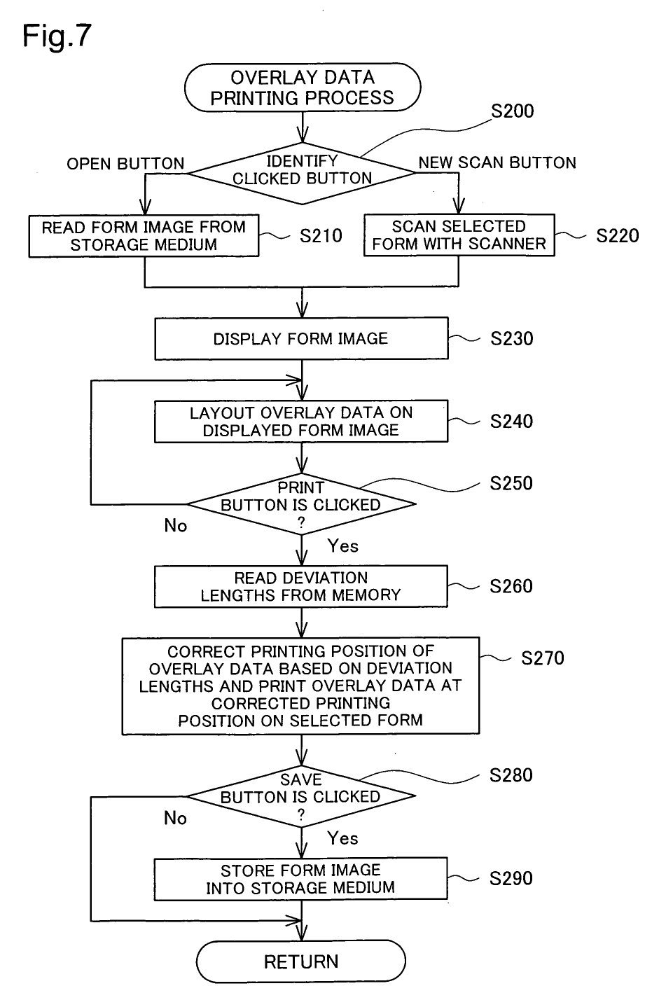

The overlay data processing device 100 of the embodiment also executes an overlay data printing process to print overlay data, such as character data, on a predetermined form. FIG. 7 is a flowchart showing the overlay data printing process, which is continually called during execution of the overlay data processing program 44.

In the call of the overlay data printing process, the CPU 10 waits until the user's click of the Open button B3 or the New Scan button B2 on the application window shown in FIG. 2 (step S200). In response to the user's click of the Open button B3, the CPU 10 reads out the user's selected form image scanned and stored in advance in a storage medium, such as the hard disk 40 (step S210). In response to the user's click of the New Scan button B2, on the other hand, the CPU 10 controls the scanner 200 to newly scan a selected form (step S220). One preferable procedure of step S220 opens a dialog box giving a message like ‘Set a selected form in the scanner’, prior to the actual scanning of the selected form by the scanner 200. In response to the user's click of an OK button in the dialog box, the CPU 10 controls the scanner 200 to start scanning the selected form. This application prevents the scanner 200 from starting scanning without the selected form set in the scanner 200.

The scanner 200 scans the selected form at a relatively low resolution, for example, 72 dpi that is a standard resolution of the monitor 70. In the overlay data printing process, the scanned form image is used only for the purpose of display on the monitor 70 and is not used for printing that requires the high resolution. Scanning at the low resolution desirably enhances the processing speed.

The CPU 10 then displays the form image obtained by scanning the selected form with the scanner 200 at step S220 or the form image read out of the hard disk 40 at step S210 in the form display area LA of the application window shown in FIG. 2 (step S230). The CPU 10 receives the user's entry of desired overlay data, for example, character strings and figures, after a click of the Overlay Data Entry button B4 and lays out the entered overlay data on the form image (step S240). The user is allowed to specify the position and the size of each overlay data, for example, a character string or a figure, and set various attributes of the overlay data, for example, color, positional adjustment, modification, or ornament, while visually checking the form image displayed on the monitor 70.

The CPU 10 then detects the user's click of the Print button B5 (step S250). In the event of no click of the Print button B5, the processing flow returns to step S240 for further layout of overlay data on the form image. In the event of a click of the Print button B5, on the other hand, the CPU 10 reads out the deviation lengths stored in the memory 20 or the hard disk 40 by the calibration process described previously (step S260).

The CPU 10 subtracts the deviation lengths, which are read from the memory 20 or the hard disk 40, from the position of each overlay data laid out at step S240 to correct the printing position of the overlay data and outputs the overlay data of the corrected position as print data to the printer 300 (step S270). This series of processing compensates for the deviation between the origin of the scannable area SA and the origin of the printable area PA and prints each overlay data at an expected position on the selected form. When the rotational deviation is additionally stored in the memory 20 or the hard disk 40, the correction of the printing position also takes into account the rotational deviation. The layout position may be shifted, instead of the correction of the printing position. Namely this correction step corrects the printing position of each overlay data relative to the selected form.

One preferable procedure of step S270 opens a dialog box giving a message like ‘Set the selected form identical with the form image displayed on the monitor’, prior to the actual printing of the overlay data on the selected form. In response to the user's click of an OK button in the dialog box, the CPU 10 controls the printer 300 to start printing the overlay data on the selected form. This application enables the desired overlay data to be adequately printed on the selected form.

The printer 300 may print the overlay data in a maximum printable paper size, regardless of the size of the selected form actually set in the printer 300. This application ensures printing of the overlay data to the respective edges (especially to the lower edge and the right edge) of the selected form. Such fixation of the printing size to the maximum printable paper size does not require the user to individually set the size of each form in the printer driver and thus enhances the user's convenience in printing of overlay data on the selected form.

The CPU 10 then detects the user's click of the Save button B6 (step S280). In the event of a click of the Save button B6, the CPU 10 stores the form image displayed on the monitor 70 into the storage medium, such as the hard disk 40 (step S290). The entered overlay data, for example, character strings and figures, and their layout positions may additionally be stored with the form image. In the event of no click of the Save button B6, on the other hand, the CPU 10 terminates the overlay data printing process without the storage. The processing of steps S280 and S290 is not restricted to the timing after completion of printing the overlay data but may be executable at any arbitrary timing after the scan of the form image at step S220.

The overlay data processing device 100 of the embodiment allows the user to lay out desired overlay data, for example, character strings, on the form image displayed on the monitor 70. This ensures printing of desired overlay data on any selected form with high accuracy. The printing position of each overlay data is determined by taking into account the computed deviation lengths between the scannable area SA of the scanner 200 and the printable area PA of the printer 300. This further enhances the accuracy of printing on the selected form. The technique of the embodiment ensures printing of character strings or any other overlay data within a preset layout frame printed on any selected form, for example, postcard, writing paper, or label. The technique of the embodiment also facilitates adjustment of the size balance and the color balance of any additional character strings with printed character strings in the case of additional printing or overlay printing on a printed sheet and enables the totally-balanced printing at adequate positions.

The embodiment discussed above is to be considered in all aspects as illustrative and not restrictive. There may be many modifications, changes, and alterations without departing from the scope or spirit of the main characteristics of the present invention. Some examples of possible modification are given below.

In the overlay data printing process, the CPU 10 may adopt a known image processing technique, for example, area extraction or edge detection, to specify the size of a selected form scanned by the scanner 200 and allows layout of overlay data, for example, a character string, only in the specified size. This application effectively prevents the character string from being printed out of the area of the selected form.

In the calibration process, when the size of the printing paper set in the printer 300 for printing the calibration pattern is different from the size of the calibration paper scanned by the scanner 200, the CPU 10 may give a predetermined error message indicating the wrong paper. This application ensures accurate computation of the deviation lengths. The size of the calibration paper scanned by the scanner 200 is specified by the known image processing technique, for example, area extraction or edge detection.

The overlay data processing device 100 may additionally have a function of converting entered overlay data, for example, a character string, laid out on the form image into a barcode or a QR code and printing the converted barcode or QR code on a selected form. This application enables coded address and name to be readily printed on name cards.

In the structure of the embodiment shown in FIG. 1, the scanner 200 and the printer 300 are constructed as independent, separate devices. The technique of the invention may be applied to a complex machine having both the functions of the scanner and the printer. The complex machine may be designed to have a common paper feed mechanism for printing and scanning. The complex machine of this application enables detection of the difference between a printable area and a scannable area with high accuracy.

In the structure of the embodiment shown in FIG. 1, the overlay data processing device 100, the scanner 200, the printer 300, and the monitor 70 are constructed as independent, separate devices. The technique of the invention may be applied to a complex machine having all the functions of the overlay data processing device, the scanner, the printer, and the monitor. The single machine of this application enables printing of overlay data on a selected form with high accuracy.

All changes within the meaning and range of equivalency of the claims are intended to be embraced therein. The scope and spirit of the present invention are indicated by the appended claims, rather than by the foregoing description.

What is claimed is:

1. An overlay data processing method that is executed by a computer connected with at least a scanner to process overlay data, said method comprising:
controlling the scanner to scan a selected form and generate a scanned form image;
displaying the scanned form image on a display screen;
receiving entry of overlay data, which is to be printed on the selected form;
laying out the entered overlay data on the displayed form image; and
determining a relative printing position of the laid-out overlay data on the selected form by taking into account a deviation of a scanning position by the scanner.

2. An overlay data processing method in accordance with claim 1, said method further comprising:
controlling a printer connected to the computer to print a calibration pattern at a predetermined printing position on preset printing paper set in the printer;
controlling the scanner to scan the printing paper with the printed calibration pattern;
computing a deviation between a printable area of the printer and a scannable area of the scanner, based on the printing position of the calibration pattern and a scanned position of the calibration pattern by the scanner;
calculating a correction amount of the relative printing position of the overlay data from the computed deviation to determine a corrected printing position of the overlay data on the selected form; and
controlling the printer to print the overlay data at the corrected printing position on the selected form set in the printer.

3. An overlay data processing method in accordance with claim 2, wherein the correction amount of the relative printing position is either a correction amount of a layout position or a correction amount of a printing position of the overlay data.

4. An overlay data processing method in accordance with claim 2, wherein said calibration pattern printing step prints a predetermined index for clearly indicating a top and a bottom of the printing paper, simultaneously with printing the calibration pattern.

5. An overlay data processing method in accordance with claim 2, wherein the calibration pattern includes multiple marks of a predetermined shape.

6. An overlay data processing method in accordance with claim 5, wherein the multiple marks have a circular shape.

7. An overlay data processing method in accordance with claim 2, wherein said overlay data printing step controls the printer to print the overlay data at the corrected printing position in a maximum printable paper size, regardless of a size of the selected form actually set in the printer.

8. A program product that causes a computer connected with at least a scanner to process overlay data, said program product having program code and a storage medium; wherein said program code comprising:
a first program code of controlling the scanner to scan a selected form and generate a scanned form image;
a second program code of displaying the scanned form image;
a third program code of receiving entry of overlay data, which is to be printed on the selected form;
a fourth program code of laying out the entered overlay data on the displayed form image; and
a fifth program code of determining a relative printing position of the laid-out overlay data on the selected form by taking into account a deviation of a scanning position by the scanner.

9. A storage medium that stores said first to fifth program codes included in the program code in accordance with claim 8 in a computer readable manner.

10. An overlay data processing device that prints overlay data on a selected form, said overlay data processing device comprising:
a scanner that scans an image;
a form image generation unit that controls the scanner to scan the selected form and generate a scanned form image;
a display unit that displays the scanned form image on a display screen;
an overlay data entry unit that receives entry of overlay data, which is to be printed on the selected form;
a layout unit that lays out the overlay data entered by the overlay data entry unit on the displayed form image; and
a printing position determination unit that determines a relative printing position of the laid-out overlay data on the selected form by taking into account a deviation of a scanning position by the scanner.

11. An overlay data processing device in accordance with claim 10, said overlay data processing device further comprising:
a printer that has a printing function;
a calibration pattern printing unit that controls the printer to print a calibration pattern at a predetermined printing position on preset printing paper set in the printer;
a calibration pattern scanning unit that controls the scanner to scan the printing paper with the printed calibration pattern;
a deviation computation unit that computes a deviation between a printable area of the printer and a scannable area of the scanner, based on the printing position of the calibration pattern by the calibration pattern printing unit and a scanned position of the calibration pattern by the calibration pattern scanning unit;
a printing position correction unit that calculates a correction amount of the relative printing position of the overlay data from the computed deviation by the deviation computation unit to determine a corrected printing position of the overlay data on the selected form; and
an overlay data printing unit that controls the printer to print the overlay data at the corrected printing position on the selected form set in the printer.

12. An overlay data processing device in accordance with claim 10, wherein the scanner and the printer are incorporated in an identical casing.
